(19) United States
(12) Patent Application Publication
(10) Pub. No.: US 2014/0061403 A1
(43) Pub. Date: Mar. 6, 2014

(54) Bicycle Mounting Arrangement

(71) Applicant: Heinz Kettler GmbH & Co. KG, Ense (DE)

(72) Inventors: Karin Kettler, Ense (DE); Joachim Kettler, Ense (DE)

(73) Assignee: Heinz Kettler GmbH & Co. KG, Ense (DE)

(21) Appl. No.: 13/775,213

(22) Filed: Feb. 24, 2013

(30) Foreign Application Priority Data
Aug. 22, 2012 (DE) 20 2012 008 045.8

(51) Int. Cl. B62H 3/00

(52) U.S. Cl. CPC B62H 3/00
USPC 248/125.7; 248/121

(57) ABSTRACT

The invention relates to a bicycle mounting arrangement comprising:
a clamping device (100) which is constructed for a clamping connection with respect to a portion of a bicycle frame (104),
a stand device (200) which comprises at least one stand base, and
connection means for connecting the clamping device to the stand device,
   wherein the connection means have a conical portion (214) on the stand device (200) and a hollow space on the clamping device (100), or wherein the connection means have a conical portion on the clamping device (100) and a hollow space on the stand device (200), wherein the conical portion is able to be inserted into the hollow space in order to connect the clamping device to the stand device.

### FIELD OF THE INVENTION

The present invention relates to a bicycle mounting arrangement comprising a clamping device which is constructed for a clamping connection with respect to a portion of a bicycle frame, a stand device which comprises at least one stand base, and connection means for connecting the clamping device to the stand device.

### BACKGROUND

Bicycle mounting arrangements having a clamping device which is constructed for a clamping connection with respect to a portion of a bicycle frame and a stand device which comprises at least one stand base and connection means for connecting the clamping device to the stand device are known from the prior art. For example, DE 90 00 903 U1 describes a bicycle mounting arrangement in which a clamping device is connected to a stand device by means of a screw connection. The bicycle is then retained in a mounting position in which a repair or a modification of the bicycle is facilitated for a user. The term “stand base” is intended in this instance to refer to a component which enables the stand device to be erected in a perpendicular position on a substrate.

The bicycle mounting arrangements from the prior art in particular have the disadvantage that it is difficult for a user to connect the clamping device to the stand device. This is particularly the case when the clamping device is connected to a bicycle frame portion. The user must on the one hand lift the heavy bicycle frame portion and at the same time ensure that the clamping device is connected to the stand device. Furthermore, the user, if he would like to change the position of the bicycle, must first loosen a screw, move the bicycle into the desired position and then tighten the screw again. In particular, tightening the screw and holding the bicycle in the desired position at the same time is very difficult for one person alone.

In this regard, an object of the invention is to provide improved bicycle mounting arrangements, in particular for improved connection between the clamping device and stand device and for simplified securing of the bicycle in the mounting position.

### SUMMARY

These objects are achieved by bicycle mounting arrangements comprising a clamping device which is constructed for a clamping connection with respect to a portion of a bicycle frame, a stand device which comprises at least one stand base, and connection means for connecting the clamping device to the stand device,

Embodiments of the connection means have a conical portion on the stand device and a hollow space on the clamping device or for the connection means to have a conical portion on the clamping device and a hollow space on the stand device, the conical portion being able to be inserted into the hollow space in order to connect the clamping device to the stand device.

The conical portion of the connection means in particular has the advantage that the connection of the stand device to the clamping device is simplified. A user may, for example, first connect the connection means to the stand device. Subsequently, the clamping device may be connected to the bicycle frame. In order to connect the clamping device to the stand device, the conical portion can now be inserted into the hollow space. This has the advantage that the user does not have to hold the clamping device at a precise angle and in a precise position relative to the stand device.

Owing to the conical portion, automatic centering is achieved. If the user does not hold the clamping device at the correct angle and/or in the correct position in order to produce a connection with respect to the stand device, the clamping device is guided into the correct position and into the correct angle during fitting onto the connection means by the travel of the conical portion.

The conical portion may be secured in the hollow space, for example, by means of a cylindrically shaped securing element and a resilient element. If the hollow space is arranged in the clamping device, the clamping device comprises the securing element and the resilient element. If the hollow space is arranged in the stand device, the stand device comprises the securing element and the resilient element. The securing element may, for example, be a screw or a pin-like element. The resilient element may, for example, be a resiliently deformable spring. If the securing element and the resilient element are arranged on the clamping device, a recess for the securing element may be arranged in the stand device. If the securing element and the resilient element are arranged on the stand device, a recess for the securing element may be arranged in the clamping device. The resilient element may be constructed to retain the securing element in the recess when the stand device is connected to the clamping device and to press the securing element against the conical portion when the conical portion is inserted into the hollow space.

It is also possible for the connection means to comprise a wedge-like portion and for the resilient element to be constructed to press the securing element against the wedge-like portion when the wedge-like portion is inserted into the hollow space. The wedge-like portion thus applies to the securing element during the movement over the wedge-like portion a force which acts counter to the force of the resilient element. When the wedge-like portion has been inserted far enough into the hollow space, the resilient element presses the securing element to the rear side of the wedge, whereby the wedge-like portion is prevented from being pulled out of the hollow space.

When the clamping device is connected to the stand device, the conical portion may be inserted into the hollow space. A resiliently deformable spring acting as a resilient element may apply a first force in the direction of the hollow space to a screw acting as a securing element. When the conical portion is inserted into the hollow space, the conical portion may apply to the securing element a second force which is counter to the first force. The securing element may thus be moved counter to the first force of the resilient element when the conical portion is inserted into the hollow space. When the connection means has been inserted so far into the hollow space that the recess is opposite the securing element, a second force is no longer applied to the securing element. The securing element can consequently be moved into the recess by the first force of the resilient element and retained there. That is to say, the securing element can engage in the recess. A releasable connection can thus be achieved between the clamping device and the stand device using the connection means. The conical portion, the recess and the securing element particularly have the advantage that inserting the conical portion into the hollow space is made particularly simple for a user and at the same time a secure, releasable connection is achieved between the stand device and the clamping device.

According to one embodiment of the invention, the securing element may be a screw and the recess may have a thread. The screw may be able to be screwed into the recess. This is particularly advantageous in order to improve the connection between the clamping device and the stand device. Owing to a screwing of the connection means, an accidental or inadvertent release of the connection of the stand device with respect to the clamping device is prevented.

In accordance with one embodiment, the stand device may comprise a lever device. The lever device may be constructed to release a connection of the connection means with respect to the stand device so that the connection means can be rotated relative to the stand device. For example, the connection of the connection means to the stand device may be a releasable, positive-locking connection. The lever device may, for example, comprise a clamping lever and a spring-like element. In a first position of the clamping lever, the connection means can be connected to the stand device in a positive-locking manner. In a second position of the clamping lever, the connection can be released by applying a force of the spring-like element.

The release of the connection between the connection means and the stand device is particularly advantageous in order to rotate the bicycle frame into a comfortable mounting position. When the connection is released, the connection means can be rotated relative to the stand device. Owing to the connection to the clamping device and the connection of the clamping device to the bicycle frame, the bicycle frame is then also rotated. A user can thus rotate the bicycle frame into a position which is particularly comfortable for him and for the operations which are to be carried out. When the desired position has been reached, the positive-locking connection between the connection means and the stand device can be reproduced by means of a movement of the clamping lever into the first position so that further movement of the connection means relative to the stand device is prevented.

According to one embodiment of the invention, the connection means and the stand device may each comprise a plate-like component which is provided with teeth. The term “plate-like” is intended in this instance to be understood to mean that the component is at least three times longer and/or wider than it is thick. In particular, round components in which this is the case are also referred to as plate-like. The positive-locking connection of the connection means with respect to the stand device may be able to be produced by means of the plate-like components, by the teeth of the plate-like components being able to engage in each other. The teeth of the plate-like component of the connection means can thus engage in the teeth of the plate-like component of the stand device. This in particular has the advantage that the positive-locking connection can be produced and released in a particularly simple manner by a user using the lever device. Furthermore, the positive-locking of the plate-like components is increased by the teeth, whereby the connection becomes more stable.

According to an embodiment of the invention, the connection means may comprise a square mandrel and a plastics component having a conical portion. In this instance, the hollow space of the clamping device may also have a square cross-sectional surface area which may substantially correspond to the cross-sectional surface area of the square mandrel. The shape of a square mandrel is particularly advantageous since a connection between the stand device and the clamping device is thus achieved which prevents rotation of the clamping device relative to the stand device and vice versa. However, it should be noted that the connection means may also have another straight portion with a polygonal cross-sectional surface area. In each case, the polygonal cross-sectional surface area of the straight portion substantially corresponds to the cross-sectional surface area of the hollow space.

Consequently, movement of the connection means when the conical portion and/or the square mandrel is/are inserted into the hollow space is prevented. When the positive-locking connection between the connection means and the stand device is closed, the clamping device cannot be rotated when the square mandrel is inserted into the hollow space of the clamping device. Consequently, inserting the square mandrel into the hollow space is simplified for the user. Owing to the conical portion, the clamping device is automatically centered relative to the stand device and can be secured in a comfortable manner using the securing element.

According to one embodiment of the invention, the clamping device may be a clamping claw. There may be arranged on the clamping claw a screw which can be screwed into the clamping claw so that a clamping force of the clamping connection of the clamping claw is increased. The clamping claw may in this instance have two clamping faces between which the portion of the bicycle frame can be clamped. If the portion of the bicycle frame is located between the clamping faces, the screw may be screwed into the clamping claw and thus increase the clamping force on the portion of the bicycle frame which is located between the clamping faces. Particularly secure clamping is thereby achieved.

### BRIEF DESCRIPTION OF THE DRAWINGS

Other features and advantages of the present invention will be appreciated from the following description of preferred embodiments with reference to the appended drawings. The same reference numerals are used for similar features or components and for features or components which have similar functions. In the drawings:

FIG. 1 is a schematic side view of a clamping device;

FIG. 2A is a schematic rear view of a stand device;

FIG. 2B is a schematic side view of a clamping device and a stand device in the state separated from each other;

FIG. 2C is a schematic front view of a stand device;

FIG. 3 is a schematic side view of a bicycle mounting arrangement, comprising a clamping device and a stand device;

FIG. 4 is a schematic side view of a bicycle mounting arrangement, comprising a clamping device and a stand device;

FIG. 5A is a schematic rear view of a bicycle mounting arrangement in which the connection between the connection means and the stand device is released;

FIG. 5B is a schematic side view of a bicycle mounting arrangement in which the connection between the connection means and the stand device is released;

FIG. 5C is a schematic side view of a bicycle mounting arrangement having a rotatable clamping device;

FIG. 6A is a schematic side view of a bicycle mounting arrangement in which the connection means are connected to the stand device; and

FIG. 6B is a schematic rear view of a bicycle mounting arrangement in which the connection means are connected to the stand device.

### DESCRIPTION

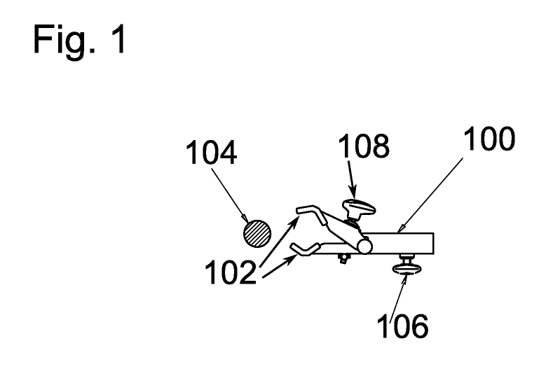

FIG. 1 is a schematic side view of a clamping device 100. The clamping device 100 comprises two clamping faces 102 which are constructed for receiving a portion of a bicycle frame 104. Furthermore, the clamping device 100 comprises a screw 108 by means of which the clamping force of the clamping faces 102 on the portion of the bicycle frame 104 can be increased. The portion of the bicycle frame 104 may, for example, be an upper or a lower pipe.

There is further arranged on the clamping device 100 a securing element 106. This is constructed in order to engage in a recess of a stand device (not shown in FIG. 1). This is explained in greater detail in connection with the following figures.

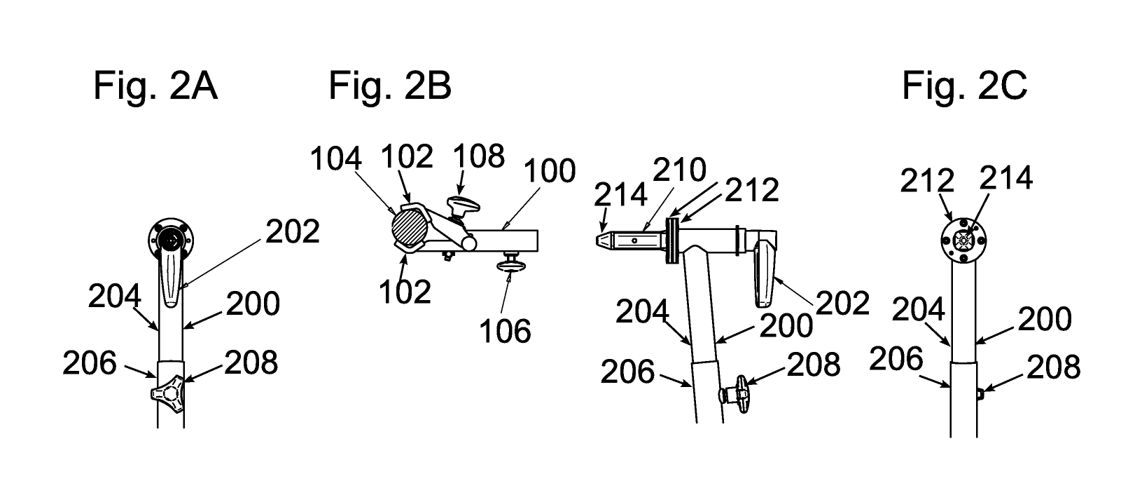

FIG. 2A is a schematic rear view of a stand device 200. The stand device 200 comprises two portions 204 and 206. The two portions 204 and 206 are connected to each other by means of a screw 208. However, it should be noted that the stand device 200 may also be constructed in one piece or integrally.

The stand device 200 further comprises a lever device 202, which is constructed for the production and release of a connection of the stand device with connection means (not shown in FIG. 2A). This is explained in greater detail in connection with the following figures.

FIG. 2B is a schematic side view of a clamping device 100 and a stand device 200 in the non-connected state. The portion of the bicycle frame 104 is clamped between the clamping faces 102 of the clamping device 100. The screw 108 applies a clamping force to the portion of the bicycle frame 104 located between the clamping faces 102.

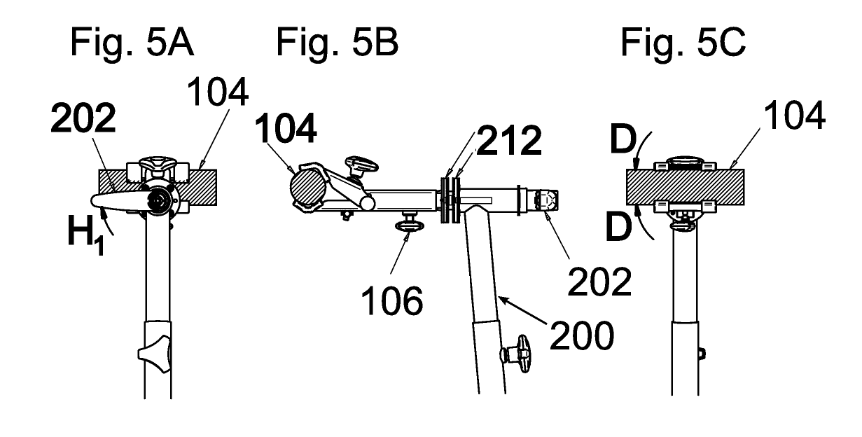

On the stand device 200 there is arranged at one side a conical portion 214 and at the other side a plate-like component 212. Between the conical portion 214 and the plate-like component 212 there is arranged a straight portion 210 which may, for example, be a square mandrel. It is also possible for the straight portion 210 to have a polygonal cross-sectional surface area. The stand device 212 also comprises a plate-like component 212. Both plate-like components 212 may have teeth which engage in each other. Owing to the two plate-like components 212, the straight portion 210 and the stand device 212 are connected to each other in a positive-locking manner. The positive-locking connection may be released by a movement of the lever device 202. This is explained in greater detail with reference to FIGS. 5A-C.

The conical portion 214 and the straight portion 210 can be inserted into a hollow space of the clamping device 100. The connection means may in this instance comprise a straight portion 210 onto which a conically shaped plastics component is placed. In such a case, the cross-sectional surface area of the hollow space of the clamping device 100 is also constructed in a square manner so that rotation of the square mandrel in the hollow space is prevented.

The conical portion 214 is particularly advantageous since it makes it easier for a user to connect the clamping device 100 to the stand device 200. Owing to the conical portion 214, a user does not have to hold the clamping device 100 precisely in the correct position relative to the stand device 200 in order to be able to insert the conical portion 214 into the hollow space. It is sufficient for the user to hold the clamping device 100 approximately in the correct position. When the conical portion 214 is inserted into the hollow space of the clamping device 100, the clamping device 100 is centered relative to the stand device 200. It is thus particularly simple for the user to insert the conical portion 214 and the straight portion 210 into the hollow space of the clamping device 100.

FIG. 2C is a schematic front view of a stand device 200. In this view, the conical portion 214 arranged on the stand device 200 can be seen. The plate-like component 212 for forming a positive-locking connection with respect to the stand device 200 can also be seen.

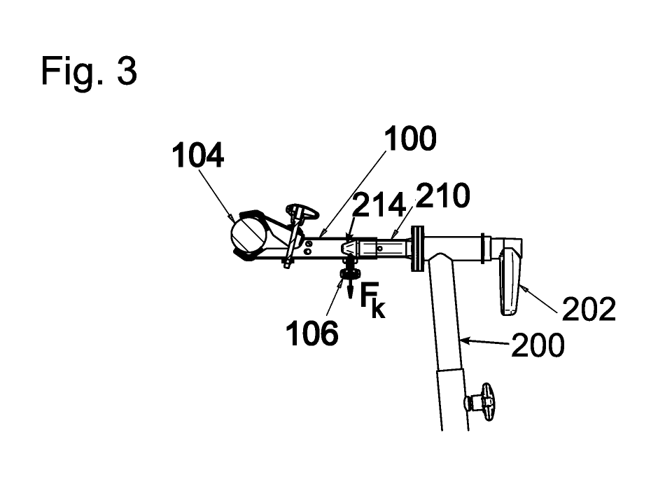

FIG. 3 is a schematic side view of a bicycle mounting arrangement having a clamping device 100 and a stand device 200. The straight portion 210 is partially inserted into the clamping device 100. The conical portion 214, during insertion, applies a force Fₖ to the securing element 106. In FIG. 3, this force is directed downward. However, the force could also be directed in another direction when the securing element 106 is arranged at another side of the clamping device 100. For example, the securing element 106 could also be arranged at the upper side. In this instance, the force Fₖ would also be directed upward.

Owing to the force Fₖ, the securing element 106 is pressed downward out of the clamping device 100. A resilient element not illustrated in the figures acts counter to the force Fₖ. This may, for example, be a spring. The securing element 106 thereby does not fall downward out of the clamping device 100.

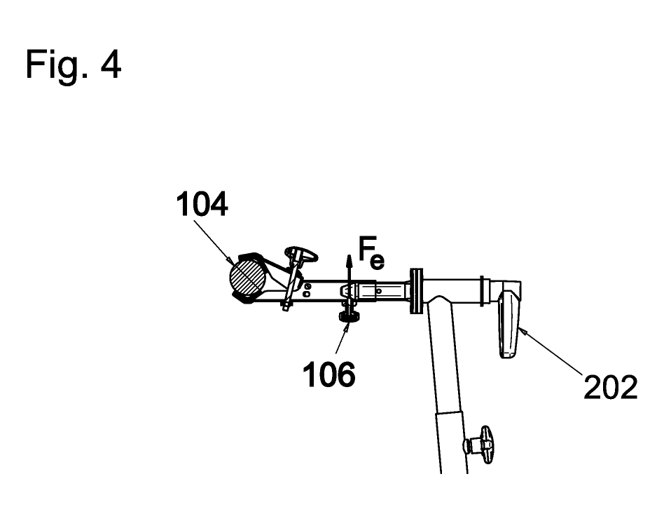

FIG. 4 is a schematic view of a bicycle mounting arrangement similar to FIG. 3. FIG. 4 indicates the force Fₑ which acts counter to the force Fₖ. The force Fₑ is applied to the securing element 106 by means of a resilient element (not illustrated). In the state illustrated in FIG. 4, the securing element 106 is pressed by the force Fₑ against the conical portion 214. When the straight portion 210 is inserted further into the clamping device 100, the securing element 106 is pressed against the straight portion 210.

FIGS. 5A to 5C are various schematic views of the bicycle mounting arrangement. The straight portion 210 is inserted so far into the clamping device 100 that the securing element 106, for example a screw, has been pressed into a recess at the lower side of the straight portion 210 by means of the force Fₑ described above. The clamping device 100 is thus connected to the square mandrel. In the embodiment of the invention in which the securing element 106 is a screw, there may be arranged in the recess of the straight portion 210 a thread which is constructed so as to correspond to this screw so that the screw can be screwed into the recess. By screwing the screw into the recess, the connection of the straight portion 210 to the clamping device 100 becomes more stable.

FIG. 5A shows that the lever device 202 has been moved in a first direction H₁. The lever device 202 is then located in a horizontal position. FIG. 5B shows that, in such a position of the lever device 202, the positive-locking connection between the straight portion 210 and the stand device 200 has been released. The lever device 202 may comprise to this end a resilient element, for example a spring. When the lever device is rotated in the direction H₁, a resilient force then acts on the plate-like component 212 of the stand device 200, whereby the positive-locking connection is released.

Since the positive-locking connection between the stand device 200 and the straight portion 210 is released, the straight portion 210 can be rotated relative to the stand device 200. Owing to the connection of the straight portion 210 to the clamping device 100 by means of the securing element 106, a rotation of the clamping device 100 also results in a rotation of the straight portion 210. Owing to the released connection between the straight portion 210 and the stand device 200, therefore, the clamping device 100 can be rotated together with the straight portion 210 relative to the stand device 200. This would not be possible with a positive-locking connection between the straight portion 210 and the stand device 200. A rotation of the clamping device 100 relative to the stand device 200 is therefore enabled in that the positive-locking connection between the straight portion 210 and the stand device 200 has been released.

In FIG. 5C, it is illustrated by means of the arrows D that the portion of the bicycle frame 104 can now be rotated. It is thus made possible for a user to rotate the bicycle frame 104 relative to the stand device 200 in a manner which is most comfortable for him and the operations to be carried out. For example, the front or rear wheel of the bicycle may be raised so that operations to be carried out at that location can be carried out at a convenient height in the standing position.

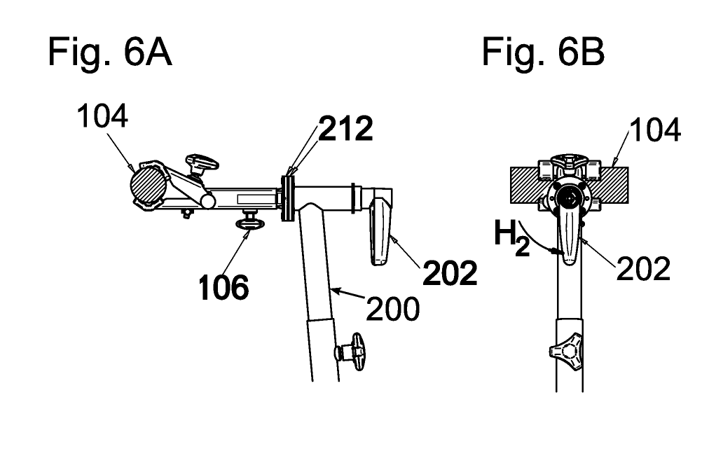

In FIGS. 6A and 6B, it is shown that the positive-locking connection between the straight portion 210 and the stand device 200 has been reproduced. This was achieved by means of a movement of the lever device 202 in the direction H₂. In the case of a movement of the lever device 202 in the direction H₂, the force applied to the plate-like component 212 of the stand device 200 by the resilient element (not illustrated) of the lever device 202 is reduced so that the plate-like component 212 of the stand device 200 again moves toward the plate-like component arranged at the straight portion 210. The two plate-like components 212 then again produce a positive-locking connection between the stand device 200 and the straight portion 210. Rotation of the straight portion 210 relative to the stand device 200 is no longer possible. The portion of the bicycle frame 104 is therefore securely retained by the bicycle mounting arrangement. Movement of the bicycle frame 104 relative to the bicycle mounting arrangement is prevented. Consequently, a repair or any other operation can be carried out on the bicycle.

In the figures and the associated description, there have been described only bicycle mounting arrangements in which the conical portion is arranged on the stand device and the hollow space on the clamping device. However, it is also possible for the hollow space to be arranged on the stand device and the conical portion on the clamping device.

1-10. (canceled)

11. A bicycle mounting arrangement, comprising:
a clamping device which is constructed for a clamping connection with respect to a portion of a bicycle frame,
a stand device which comprises at least one stand base, and
connection means for connecting the clamping device to the stand device, wherein the connection means has a conical portion on one of the stand device and the clamping device and a hollow space on the other one of the stand device and the clamping device, wherein the conical portion is able to be inserted into the hollow space in order to connect the clamping device to the stand device.

12. The bicycle mounting arrangement as claimed in claim 11, wherein the connection means comprises a cylindrically shaped securing element on the clamping device, a resilient element on the clamping device and a recess on the stand device or the connection means comprises a cylindrically shaped securing element on the stand device, a resilient element on the stand device and a recess on the clamping device, wherein the resilient element is constructed to retain the securing element in the recess when the stand device is connected to the clamping device.

13. The bicycle mounting arrangement as claimed in claim 12, wherein the resilient element is constructed to press the securing element against the conical portion when the conical portion is inserted into the hollow space.

14. The bicycle mounting arrangement as claimed in any one of claims 12, wherein the securing element is a screw and the recess has a thread so that the securing element can be screwed into the recess.

15. The bicycle mounting arrangement as claimed in claim 11, wherein the stand device comprises a lever device which is constructed to release a connection of the connection means with respect to the stand device so that the connection means can be rotated relative to the stand device.

16. The bicycle mounting arrangement as claimed in claim 15, wherein the lever device has a spring-like element, wherein the spring-like element is constructed, when the lever device is moved, to release a positive-locking connection of the connection means with respect to the stand device.

17. The bicycle mounting arrangement as claimed in claim 16, wherein the connection means and the stand device each comprise a plate-like component which is provided with teeth, wherein the positive-locking connection of the connection means with respect to the stand device is able to be produced by means of the plate-like components, by the teeth of the plate-like components engaging in each other.

18. The bicycle mounting arrangement as claimed in claim 11, wherein the connection means comprises a square mandrel and a plastics component having the conical portion, wherein the hollow space has a cross-sectional surface area in the form of a square which substantially corresponds to the cross-sectional surface area of the square mandrel.

19. The bicycle mounting arrangement as claimed in claim 11, wherein the clamping device is a clamping claw and a screw is arranged on the clamping claw which can be screwed into the clamping claw so that a clamping force of the clamping connection of the clamping claw is increased.

20. A bicycle mounting arrangement comprising:
a clamping device which is constructed for a clamping connection with respect to a portion of a bicycle frame,
a stand device which comprises at least one stand base, and
connection means for connecting the clamping device to the stand device, wherein the connection means has a wedge-like portion on one of the stand device or the clamping device and a hollow space on the other one of the stand device or the clamping device, wherein the wedge-like portion is able to be inserted into the hollow space in order to connect the clamping device to the stand device.

21. The bicycle mounting arrangement as claimed in claim 20, wherein the connection means comprises a cylindrically shaped securing element on the clamping device, a resilient element on the clamping device and a recess on the stand device, or the connection means comprises a cylindrically shaped securing element on the stand device, a resilient element on the stand device and a recess on the clamping device, wherein the resilient element is constructed to retain the securing element in the recess when the stand device is connected to the clamping device.

22. The bicycle mounting arrangement as claimed in claim 21, wherein the resilient element is constructed to press the securing element against the wedge-like portion when the wedge-like portion is inserted into the hollow space.

23. The bicycle mounting arrangement as claimed in claim 21, wherein the resilient element is constructed to press the securing element against the wedge-like portion when the wedge-like portion is inserted into the hollow space.

24. The bicycle mounting arrangement as claimed in claim 21, characterized in that the securing element is a screw, wherein the recess has a thread so that the securing element can be screwed into the recess.

25. The bicycle mounting arrangement as claimed in claim 20, wherein the stand device comprises a lever device which is constructed to release a connection of the connection means with respect to the stand device so that the connection means can be rotated relative to the stand device.

26. The bicycle mounting arrangement as claimed in claim 25, wherein the lever device has a spring-like element, wherein the spring-like element is constructed to release a positive-locking connection of the connection means with respect to the stand device when the lever device is moved.

27. The bicycle mounting arrangement as claimed in claim 26, wherein the connection means and the stand device each comprise a plate-like component which is provided with teeth, wherein the positive-locking connection of the connection means with respect to the stand device is able to be produced by means of the plate-like components, by the teeth of the plate-like components engaging in each other.

28. The bicycle mounting arrangement as claimed in claim 20, wherein the connection means comprises a square mandrel and a plastics component having a conical portion, wherein the hollow space has a cross-sectional area in the form of a square which substantially corresponds to the cross-sectional area of the square mandrel.

29. A bicycle mounting arrangement, comprising:
a clamping device which is constructed for a clamping connection with respect to a portion of a bicycle frame,
a stand device which comprises at least one stand base, and
connection means for connecting the clamping device to the stand device, wherein the stand device comprises a lever device which is constructed to release a connection of the connection means with respect to the stand device so that the connection means can be rotated relative to the stand device.

30. A bicycle mounting arrangement, comprising:
a clamping device which is constructed for a clamping connection with respect to a portion of a bicycle frame,
a stand device which comprises at least one stand base, and
connection means for connecting the clamping device to the stand device, wherein the connection means comprises a cylindrically shaped securing element on the clamping device, a resilient element on the clamping device and a recess on the stand device or the connection means comprises a cylindrically shaped securing element on the stand device, a resilient element on the stand device and a recess on the clamping device, wherein the resilient element is constructed to retain the securing element in the recess when the stand device is connected to the clamping device.
